(19) United States
(12) Patent Application Publication
(10) Pub. No.: US 2014/0369487 A1
(43) Pub. Date: Dec. 18, 2014

(54) Method and apparatus for bridging communication requests to call centers

(71) Applicant: Armstrong Soo, San Ramon, CA (US)

(72) Inventor: Armstrong Soo, San Ramon, CA (US)

(21) Appl. No.: 13/918,908

(22) Filed: Jun. 15, 2013

(51) Int. Cl. H04M 3/523

(52) U.S. Cl. CPC H04M 3/5232
USPC 379/266.03

(57) ABSTRACT

A method to shorten hold time experienced by callers to call centers by placing predictive calls into call centers in advance to obtain favorable queue positions, and release the most favorable queue positions to callers when they indicate desires to speak with call center agents by bridging their inbound calls to the favorable positions. Most favorable positions are usually the earliest predictive calls placed that are still in the queue. The method also includes other proactive tasks that may be required to navigate automated ACD or IVR call tree, maintain the active status of call queues to ACD or IVR, detect and treat possible improper disconnection, and detect and remediate premature disconnection between callers and agents.

### FIELD OF DISCLOSURE

The present disclosure relates generally to communication systems, and more specifically, to a method and apparatus for bridging communication call requests to call centers.

### BACKGROUND

Almost all customer-oriented organizations today maintain call centers to provide customer service. However, callers often have to endure long wait time to reach live customer service representatives. In many cases, callers have to hang up and try again some other time because the hold times exceed their expectation and the callers simply do not have time to hold on anymore. This cause frustration to the callers and dissatisfaction with the providers.

In order to reduce the hold time, systems and method, such as automated decision call-tree, are introduced to prioritize and direct them to different call queues. However, all these systems and method rely on the users performing certain actions accurately, such as listening to the options offered and making appropriate selections. This kind of systems and methods do not necessarily shorten callers' hold time and is implemented more for the benefit and convenience for the call centers than callers. Benefits and convenience to the call centers include directing callers to prerecorded messages instead of connecting them to live representatives. Callers often have to disconnect and call again because they made the wrong selections. Sometimes callers are too impatient to listen the options that they will simply press the “0” on the keypad or not respond to any option hoping they will be routed to live representatives by default. Make it worse, default operator option, such as “0”, is simply not available in many call-trees today.

### SUMMARY

The following presents a simplified summary of claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present concepts of the claimed subject matter in a simplified form as a prelude to the more detailed description that is presented later.

The subject matter disclosed and claimed herein, in one aspect thereof, comprises of a telecommunication system that anticipates the demand of call volume and therefore places calls to the call centers in advance. In essence, the telecommunication systems holds the call positions in the call queue on behalf of callers who have not yet initiated the call.

When the callers are ready to speak to representatives of call centers by initiating calls, the subject matter disclosed and claimed herein, in one aspect thereof, will bridge the callers to the first available position of the call queue (i.e. the oldest calls in the queue), thus minimizing the wait time experienced by the callers, or eliminating the wait time altogether, and eliminating the frustration of navigating through any call tree.

This embodiment uses examples of voice call to illustrate the subject matter. However, any person having ordinary skill in the art will understand that the subject matter can also be applied in other queue scenarios for other media types, such as video, or combination of voice and video.

### BRIEF DESCRIPTION OF THE DRAWINGS

FIG. 1 depicts exemplary embodiments of a communication system that generates the phone calls and bridging of users to the desired customer service agents.

FIG. 2 depicts an exemplary embodiment of a portal interacting between the user and the communication systems.

FIG. 3 depicts an exemplary method operating in portions of the communication systems.

FIG. 4 depicts an exemplary diagram that shows how the claimed subject matter that minimizes callers' hold time.

FIG. 5 is a diagrammatic representation of a machine in the form of a computer system within which a set of instructions, when executed, may cause the machine to perform any one or more of the methodologies discussed herein.

### DETAILED DESCRIPTION

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed systems, methods, records or computer-readable media. Moreover, some statements may apply to some innovative features but not to others.

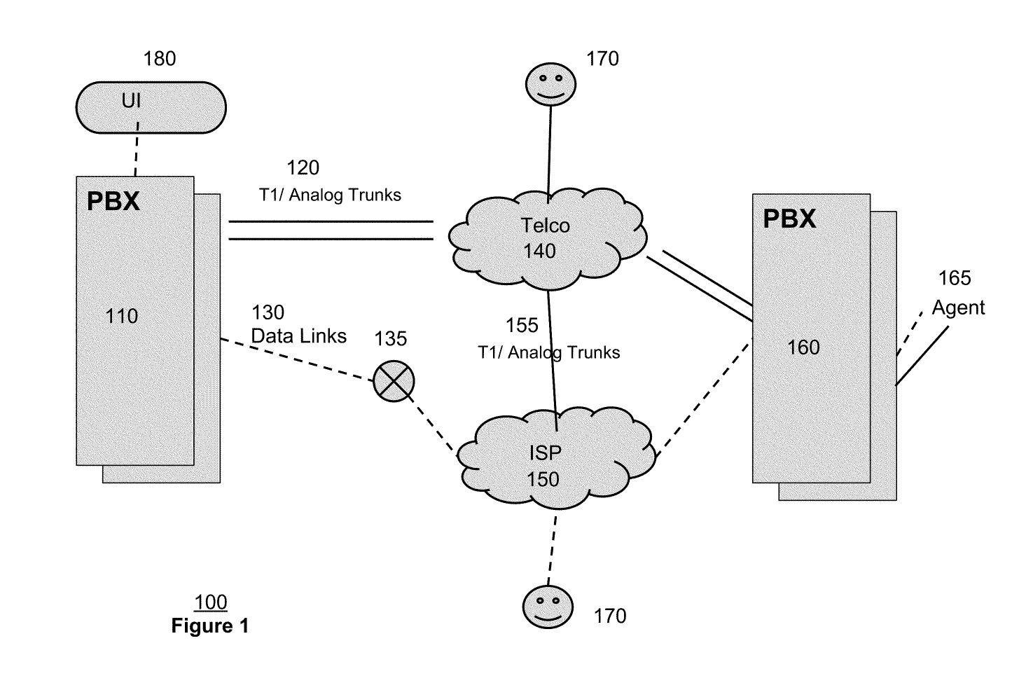

FIG. 1 illustrates one embodiment of a typical infrastructure 100 of the subject matter to generate calls and bridge users. Within the infrastructure are the PBX 110 (also known as Private Branch Exchange, or private phone systems) that provides the calling and bridging of users, and PBX 160 that represents the desired call center and its Agents 165. PBX 110 and 165 contains programmable logic that direct operation of the systems.

In this embodiment, the PBX 110 and PBX 165 may connect to the public switched telephone network (PSTN) in various means. FIG. 1 illustrates dedicated trunks 120 or internet protocol (IP) based packet switched data links 130. Trunks 120 usually terminate at Telco 140, which will subsequently transmit the calls to the Call Center's PBX 165. On the other hand, switched data links 130 often requires routers 135 to route the packets to an Internet Service Provider (ISP) 150. Please note that there may be plurality of routers 135.

In this embodiment, ISP 150 may contain specialized equipment, such as media servers and gateways, that interconnects and translates between IP based communication and PSTN based communications. ISP 150 sends translated communication to Telco 140 via Trunk 155. In the same token, the ISP receives PSTN communication from Telco 140 via Trunk 155, translates it IP-based communication and send it to the link 130.

Certain PBX is capable of processing IP-based communication without the need to be translated to PSTN first. In this embodiment, PBX 160 can communicate directly with ISP 150 on IP-based communication. Example of IP-based communication protocols is Session Initiation Protocol, or SIP.

In this embodiment, User Interface (UI) 180 embodies an user-friendly interface 200 where user 170 can interact with programmable logic of PBX 110, such as indicating users' preferences and requirements.

In this embodiment, User 170 connects to PBX 110 via Telco 140 and Trunk 120, or via ISP 150 and Link 130 and Routers 135, largely depend on the type of equipment that User 170 uses and the type of communication method is available to User 170.

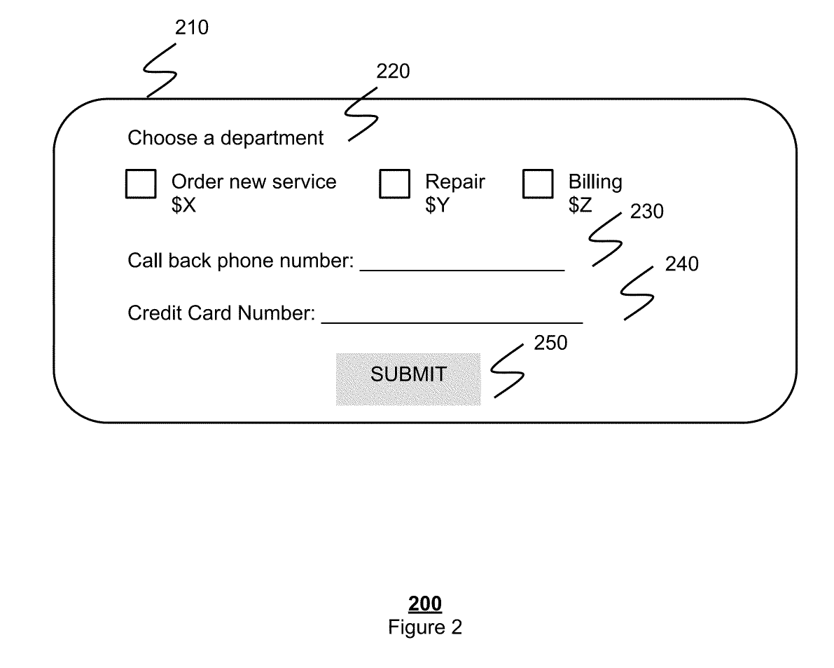

FIG. 2 illustrates a more elaborate example of UI 180. In this embodiment, 210 depicts a computer screen displaying webpage.

In this embodiment, there are 3 components to 200. 220 depicts possible options for User 170. In this example, 220 offers different destinations probably because there are different call centers for each department. On the other hand, 220 may offers different destinations because there is a different Interactive Voice Response (IVR) options for each department. It is possible that there is no need for UI to display 220 because there is only one IVR option, call center, or both regardless of the nature of the calls.

In another illustrative embodiment, User 170 provides a call-back phone number in 230. However, it is possible that 230 is not required if PBX 110 is already aware of the identity of User 170. Such identity can be established via account management that requires User 170 to login. Alternatively, User 170 may simply call in the PBX 110 directly via a special phone number, such as a toll-free number, which eliminates the need for PBX 110 to know the identity of User 170 for call back.

In this particular embodiment, PBX 110 provides a service for a fee. As such, User 170 provides a billing method in 240, such as a credit card number. However, it is possible that 240 is not required if PBX 110 is already aware of the identity of User 170. Such identity can be established via account management that requires User 170 to login. Alternatively, PBX 110 may extract the identity information from the call itself, such as Caller ID. It is also possible that 240 accepts special code, such as promotional code, that changes the price or waive the price altogether.

User 170 presses the Submit button 250 when User 170 is satisfied with the options he selected. Submission of the information triggers a predefined logic 300.

Although 180 and 200 suggests the use of UI, it is possible for User 170 to obtain service without any UI. One such scenario is when User 170 dials a specific number for specific department call center and there is no billing or operational requirement for PBX 110 to know the identity of User 170. Another such scenario is when User 170 is a prepaid user, or is a member of a prepaid group, dials a specific number for specific call center where PBX 110 is able to verify funding authorization via User 170′s Caller ID, or via User 170 successful entry of prearranged numeric Personal Identification Number (PIN) codes.

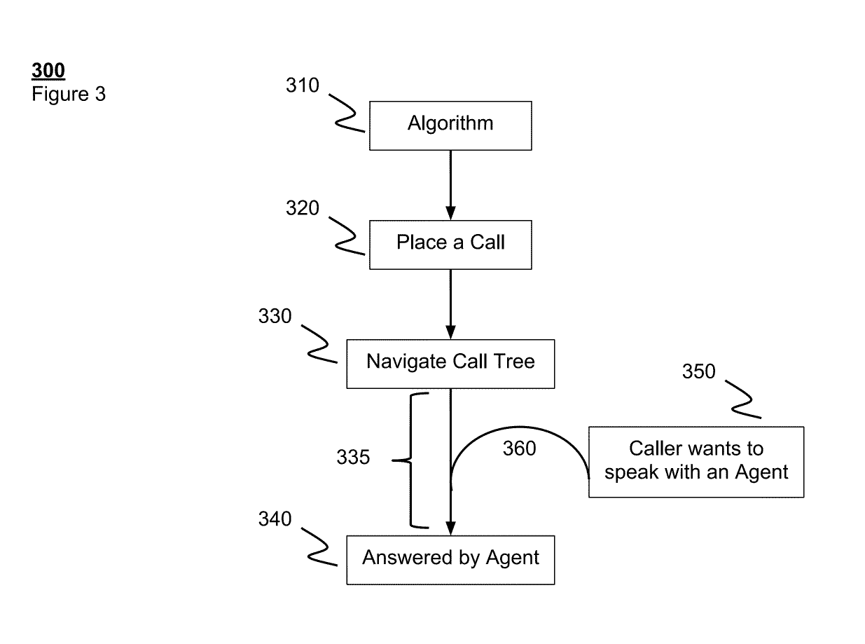

FIG. 3 depicts one possible programmable logic for PBX 110 to accomplish the task of reducing, or eliminating wait time for User 170. The programmable logic 300 may reside within PBX 110 as a built-in component or it may reside on a separate system outside of PBX 110 but interact with PBX 110 with special communication links. PBX 110 constantly provide various status updates to logic 300. In the same manner, logic 300, upon receiving status from PBX 110, provides instructions to PBX 110. Logic 300 may contain adjustable parameters that allows administrator to modify the behaviors of PBX 110 based. Logic 300 may also be capable of changing its own behavior dynamically and automatically based on information received from PBX 110.

In this embodiment, 310 illustrates an algorithm to determine when PBX 110 should place a new call to the call center phone queue. The algorithm may use factors such as time of day, quantity of user 170 used the PBX 110 within a predefined period of time, average time it takes for Agent 165 to answer the call (335), historical statistics or combination, or all, or more. Algorithm 310 may also receive information from call center PBX 160 to decide PBX 110 should place a new call to the call center phone queue.

In this embodiment, once Algorithm 310 decides it is time to place a new call to the call center phone queue, programmable code depicted as 320 will cause PBX 110 to place an outbound call to the call center and be on the call center's telephone queue. Depending on the preferred nature of the communication link, the new call may be placed in various forms. Examples are PSTN via trunks to Telco and Session Initiation Protocol (SIP) messages via IP-based data link to ISP via routers. In fact, the form of communication link is irrelevant for PBX 110 as long as it is supported.

Once PBX 165 answered the new call placed by PBX 110, programmable code 330 will navigate the IVR call tree as applicable. In one illustrative example, programmable code 330 may use specifically timed delay to provide predetermined responses to the call tree provided by PBX 160. Such delay and corresponding responses may be developed and subsequently entered into programmable code 330 by system administrators in advance.

In another illustrative example, programmable code 330 may contain sub-code, such as such as voice recognition, or artificial intelligence, that interprets and understands verbal questions or instructions provided by the IVR of PBX 160 and respond accordingly. Response may be in the form of generating a DTMF tone, simulating a speech sample, playing a sound bite from an audio file, executing another programmable code to perform other tasks, or combination of some, of all, or others. In yet another example, 330 may provide a series of specific DTMF tones when prompted by the IVR, such as account number, when the identities of the callers are known and there are corresponding predetermined account numbers.

In this embodiment, 335 commences at the point when the new call is in call queue waiting to be answered by Agent 165. 335 usually begins after programmable code 330 has successfully guided the new call through the IVR call tree of PBX 160. However 335 may commence as soon as PBX 160 answered the call if there is no IVR call tree. 335 depicts the hold time between when the call is first placed into the phone queue and the call is being answered by Agent 165.

During the hold time 335, PBX 110 may perform tasks to maintain the condition of the calls in queue and the position of the call in the queue. For example, certain communication systems sometimes require periodic transmission of control data, or media data, or all, or more to maintain the session. The communication systems may terminate the call session if it fails to transmit or receive such transmission in a timely manner. In particular, for example, IP-based communication systems may require periodic transmission of media data, sometimes known as heartbeat, to maintain the session. In such case, PBX 110 may be programmed to send a soundbite periodically to maintain session during the hold time 335. In other cases, PBX 110 may be programmed to send other messages or perform other tasks to maintain session during the hold time 335.

Additionally, during the hold time 335, PBX 110 may also perform tasks to ensure calls did not fall out of the phone queue inadvertently. Due to plurality of reasons, PBX 110 or PBX 160 may not have terminated a call properly. One such reason can be system failure of PBX 110, PBX 160 or any enabling equipment en route between PBX 110, PBX 160 and Agent 165. Another such reason can be Agent 165 answered the call from the queue but there is no User 170 at PBX 110 to talk to, hence Agent 165 tried to disconnect but unsuccessfully. Another such reason can be Agent 165 answered the call from the queue but there is no User 170 at PBX 110 to talk to, and Agent 165 is not capable of initiating a disconnect due to call center policy or other reasons and left the station subsequently after period of time.

One possible task that PBX 110 may perform during 335 to ensure call did not fall out of the phone queue inadvertently is listening to the channel periodically to see if there is any sound coming from PBX 160. It is customary for IVR to play music during 335 to ensure callers that they are still in queue. It is also customary for IVR to play announcement that contains marketing message or other messages that aims to dissipate callers' frustration of being in phone queue. During the probing, if PBX 110 hears sound coming from PBX 160, it can assume it is still in the phone queue. On the other hand, if PBX 110 listens to the channel and does not detect any sound from PBX 160 for a predefined duration, it may assume the call has fallen out of the phone queue inadvertently and initiate disconnect.

During 335, PBX 110 may also play an audio file, such as “Hello?”, to illicit a voice response from Agent 165 in the event the call was answered by Agent 165 but Agent 165 is not making any sound because there is no User 170 at PBX 110 to talk to. If the PBX 110 is successful in eliciting a voice response from Agent 165, it may be programmed to play a follow-up message asking Agent 165 to continue to hold. Otherwise, PBX 110 may assume Agent 165 has initiated disconnect and proceed to terminate the call.

While the call is in queue to be answered by Agent 165, or if the call has already been answered by Agent 165, Caller 350 expresses desire to speak with an agent. Caller 350 may express the desire to speak to an agent via the UI 200. Caller 350 may also express the desire to speak to an agent by method described in [025].

Once PBX 110 is made aware that Caller 350 expressed desire to speak with an agent, PBX 110 will, among all the concurrent calls in the queue, perform 360—selecting the most forefront call in the queue and bridging it to Caller 350. In this embodiment, the most forefront call in the queue may be the oldest call in the queue that has not already been bridged.

To anticipate that Agent 165 may have answered the call for a certain amount of time before Caller 350 was bridged on, PBX 110 may play audio file alerting Agent 165 to get ready, followed by 360.

PBX 110 may also include programmable code to call back Caller 350 if the call displayed characteristics of a failed connection. One example of a characteristic of failed call is extremely short duration, or duration distinctly shorter than average hold time, because PBX 110 bridged Caller 350 to Agent 165 when Agent 165 is just disconnecting the call. Another example is when Caller 350 disconnect the call shortly after it was bridged on because Agent 165 answered the call earlier but there was no one on the other side and had thus wandered off. In such situation, PBX 110 may call Caller 350 back making sure the previous call went well, asking Caller 350 to respond whether the call went well. PBX 110 may even offer to bridge Caller 350 again with the next most forefront call in the queue. If Caller 350 paid for the service, the PBX 110 may re-bridge Caller 350 at no additional cost. Otherwise, PBX 110 may void the transaction of Caller 350 does not express the desire to be re-bridged.

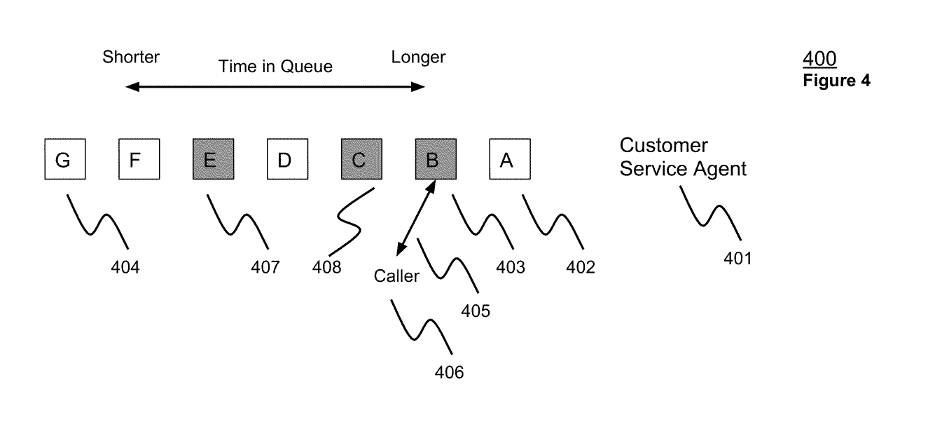

FIG. 4 depicts one example diagram that shows how calls may be handled by the subject matter systems. 401 depicts the customer service agents whom all callers try to reach. 402, 403, 404, 407 and 408 depicts position in queue in relative to time. Calls to the right of the queue that is closer to 401 depicts calls that have been waiting longer the phone queue. In the example, 402 will be the next call to be answered. On the contrary, 404 is the latest addition to the queue and will have the longest hold time comparing to others that are already in the queue. Alphabets in each call is another representation of sequence of the calls entering the queue. 403, 407 and 408 represent calls placed in queue by the subject matter systems. Other positions in the queue represent calls placed in queue not by the subject matter systems, but by callers directly without the aid of the subject matter systems.

Once 402 is answered by 401, 403 will be the next position to be answered by 401.

Calls placed by the subject matter systems enter the call queues just like any other calls placed by the callers directly without the aid of the subject matter systems.

When a caller 406 wishes to speak to agent 401 with the aid of the subject matter systems, the subject matter systems pick 403 among all the positions that the subject matter systems maintain because it is the closest position to agent 401.

Once the subject matter systems picked 403, the subject matter systems bridges on 406. The action of bridging itself is depicted as 405. In essence, 406 is able to bypass a portion of, or all of, the phone queue with the aid of the subject matter systems.

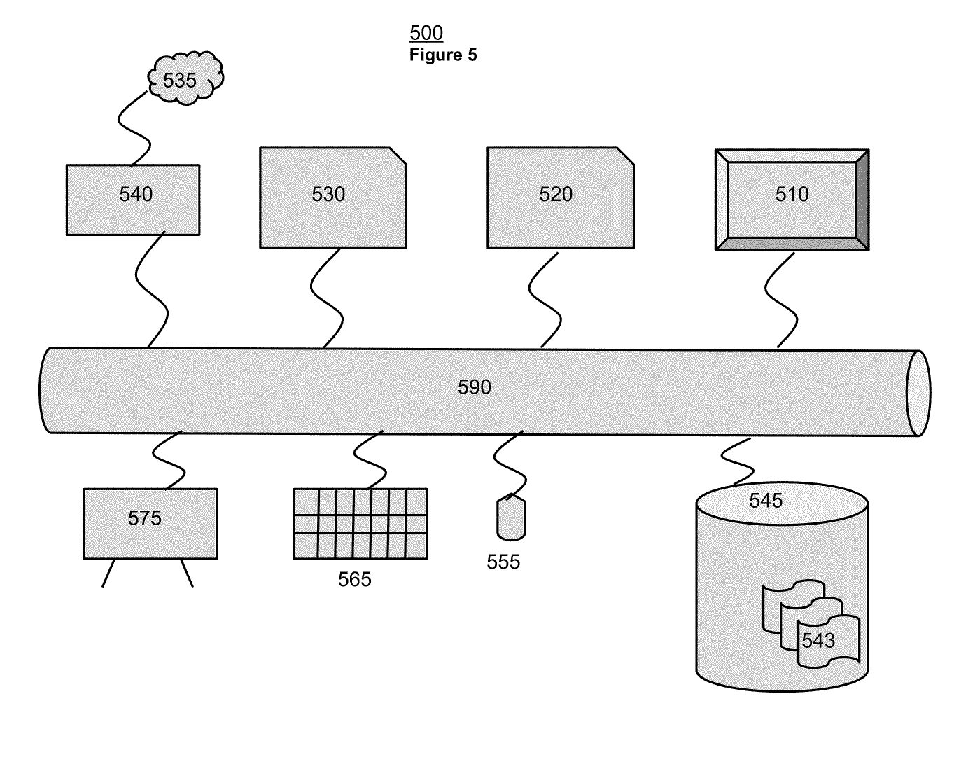

FIG. 5 depicts a representation of a typical computer system that can be used to perform the function of 110. Function of 110 can be perform by plurality of machine 500 being connected in various fashion. Alternatively, multiple instances of function 110 may be performed concurrently and independently of each other within one physical system 500. The system may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the present disclosure includes broadly any electronic device that provides voice, video or data communication.

590 depicts a representation of bus within a system where components may communicate with other components within the system to perform tasks. 590 is usually characterized as a high speed communication fabrics within the system.

The computer system 500 may include a processor 510 (e.g., a central processing unit (CPU), a graphics processing unit (GPU, or both), random access memory 520 and a static memory 530, which communicate with each other via a bus 590. 520 and 530 can be volatile or non-volatile in nature. The computer system 500 may further include a video display unit 575 (e.g., a liquid crystal display (LCD), a flat panel, or a solid state display. The computer system may include an input device 565 (e.g., a keyboard), a cursor control device 555 (e.g., a mouse), a disk drive unit 545, and a network interface device 540, which is then connected to a broader network 535.

The disk drive unit 545 may include a tangible computer-readable storage medium on which is stored one or more sets of instructions (e.g., software 543) embodying any one or more of the methods or functions described herein such as algorithm 330, including those methods illustrated above. The instructions 543 may also reside, completely or at least partially, within the main memory 520, the static memory 530, and/or within the processor 510 during execution thereof by the computer system 500. The main memory 520 and the processor 510 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 545 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the present disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although the present specification describes components and functions implemented in the embodiments with reference to particular standards and protocols, the disclosure is not limited to such standards and protocols. Each of the standards for voice communication (e.g., SIP, T1 . . . etc.) represent examples of the state of the art. Such standards are from time-to-time superseded by faster or more efficient equivalents having essentially the same functions.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computing device comprising: a memory storing computer instructions; and a controller communicatively coupled to the memory, wherein the controller, responsive to executing the computer instructions, performs operations comprising: making outbound calls to call centers at optimal interval; maintaining multiple concurrent call sessions to the same call centers;
receiving requests from other devices intending to be connected to the concurrent call sessions with call centers; selecting the oldest concurrent sessions to call centers; bridging the the oldest concurrent sessions to call centers with the devices requesting the connection; keeping track of call duration; polling the requesting devices for settlement options when call durations meet certain predetermined criteria, or not meeting certain predetermined criteria.

2. A method of claim 1, where an algorithm that determines optimal calling interval to call centers.

3. A method of claim 1, where software instructions navigate calls to call centers through automated call trees.

4. A method of claim 1, where calls to call centers that are not bridged and are not properly disconnected are detected and disposed of.

5. A method of claim 1, where keepalives are provided for every unbridged calls to call centers to prevent being disconnected inadvertently.

6. A method of claim 1, where software instructions detect if the call centers have disconnected calls improperly.

7. A method of claim 1, where software instructions keep track of status and duration of each unbridged calls to call centers.

8. A method of claim 1, where software instructions identify the oldest unbridged call to call centers.

9. A method of claim 1, where software instructions bridge users who want to speak to call centers to the oldest unbridged call to call centers.

10. A method of claim 1, where software instructions use algorithm to evaluate possibility of bridged users not able to speak to call centers and, if determined that bridged users probably not able to speak to call centers, initiate separate communications to solicit the status and desired deposition from users.

11. A method of claim 1, where software instructions bridge users to the call centers again whose earlier attempt to be bridged to call centers failed.
